(19) United States
(12) Patent Application Publication
(10) Pub. No.: US 2011/0275517 A1
(43) Pub. Date: Nov. 10, 2011

(54) SYNERGISTIC HERBICIDAL COMPOSITION CONTAINING A DICAMBA DERIVATIVE AND A GLYPHOSATE DERIVATIVE

(75) Inventors: Norbert M. Satchivi, Westfield, IN (US); Terry R. Wright, Carmel, IN (US)

(73) Assignee: DOW AGROSCIENCES LLC, Indianapolis, IN (US)

(21) Appl. No.: 13/099,552

(22) Filed: May 3, 2011

Related U.S. Application Data
(60) Provisional application No. 61/331,045, filed on May 4, 2010.

(51) Int. Cl. A01N 57/20; A01P 13/00

(52) U.S. Cl. 504/127

(57) ABSTRACT

An herbicidal composition containing (a) an herbicidal dicamba derivative component and (b) an herbicidal glyphosate derivative component provides synergistic control of selected weeds.

### CROSS REFERENCE TO RELATED APPLICATIONS

This application claims the benefit of U.S. Provisional Patent Application Ser. No. 61/331,045 filed May 4, 2010.

### FIELD OF THE INVENTION

This invention concerns a synergistic herbicidal composition containing (a) a dicamba derivative and (b) a glyphosate derivative.

### BACKGROUND OF THE INVENTION

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use.

In some cases, herbicidal active ingredients have been shown to be more effective in combination than when applied individually and this is referred to as “synergism.” As described in the Herbicide Handbook of the Weed Science Society of America, Ninth Edition, 2007, p. 429, “‘synergism’[is] an interaction of two or more factors such that the effect when combined is greater than the predicted effect based on the response of each factor applied separately.” The present invention is based on the discovery that substituted phenoxy alkanoic acid derivatives and glyphosate derivatives, already known individually for their herbicidal efficacy, display a synergistic effect when applied in combination.

For example, dicamba, 3,6-dichloro-2-methoxybenzoic acid, is a selective systemic herbicide used to control annual and perennial broad-leaved weeds in various crops as well as in non-crop land. It is commercially available, for example, as a dimethylammonium salt such as Banvel™ herbicide from Arysta LifeScience and as a diglycolamine salt such as Clarity™ herbicide from BASF.

Glyphosate, N-(phosphonomethyl)glycine, is a non-selective systemic herbicide used to control annual and perennial grasses and broad-leaved weeds, particularly in crops that have been genetically modified to be tolerant of glyphosate. It is commercially available, for example, as an isopropylammonium salt such as Glyphomax P1us™ herbicide from Dow AgroSciences, as a potassium salt such as Roundup PowerMax™ herbicide from Monsanto, as a diammonium salt such as Touchdown™ herbicide from Syngenta, or as a dimethylammonium salt such as Durango™ herbicide from Dow AgroSciences.

### SUMMARY OF THE INVENTION

The present invention concerns a synergistic herbicidal mixture comprising an herbicidally effective amount of (a) a dicamba derivative and (b) a glyphosate derivative. The compositions may also contain an agriculturally acceptable adjuvant or carrier.

The present invention also concerns a method of controlling the growth of undesirable vegetation, particularly in crops that are tolerant, either naturally or through genetic modification, to the active herbicides of the synergistic mixture, and the use of this synergistic composition.

The species spectra of the compounds of the synergistic mixture, i.e., the weed species which the respective compounds control, are broad and highly complementary. While glyphosate is a non-selective herbicide, resistance to glyphosate by several weed species, for example, horseweed (Conyza Canadensis, ERICA), giant and common ragweeds (Ambrosia trifida, AMBTR and Ambrosia artemisiifolia), and various amaranths (Amaranthus spp., AMASS) have been well documented. Additionally, certain common lambsquarters (Chenopodium album L., CHEAL) biotypes are difficult to control (resistant) with glyphosate. Recent reports of dicamba-resistant CHEAL have been reported. The synergistic mixture of dicamba and glyphosate is particularly effective at controlling these glyphosate- and dicamba-resistant weeds and maintaining the utility of these herbicides. Other weeds which the mixture of dicamba and glyphosate synergistically control include spiderwort (Commelina benghalensis; COMBE).

### DETAILED DESCRIPTION OF THE INVENTION

The term herbicide is used herein to mean an active ingredient that kills, controls or otherwise adversely modifies the growth of plants. An herbicidally effective or vegetation controlling amount is an amount of active ingredient which causes an adversely modifying effect and includes deviations from natural development, killing, regulation, desiccation, retardation, and the like. The terms plants and vegetation include germinating seeds, emerging seedlings and established vegetation.

Herbicidal activity is exhibited by the compounds of the synergistic mixture when they are applied directly to the plant or to the locus of the plant at any stage of growth or before planting or emergence. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted as is known in the art to promote non-selective or selective herbicidal action.

Generally, it is preferred to apply the composition of the present invention postemergence to relatively immature undesirable vegetation to achieve the maximum control of weeds.

Dicamba derivatives and glyphosate derivatives mean the acids themselves and their agriculturally acceptable esters and salts.

Suitable salts include those derived from alkali or alkaline earth metals and those derived from ammonia and amines. Preferred cations include sodium, potassium, magnesium, and aminium cations of the formula:

R₁R₂R₃ R₄N⁺

wherein R₁, R₂, R₃ and R₄ each, independently represents hydrogen or C₁-C₁₂ alkyl, C₃-C₁₂ alkenyl or C₃-C₁₂ alkynyl, each of which is optionally substituted by one or more hydroxy, C₁-C₄ alkoxy, C₁-C₄ alkylthio or phenyl groups, provided that R₁, R₂, R₃ and R₄ are sterically compatible. Preferred amine salts are those derived from ammonia, methylamine, dimethylamine, trimethylamine, isopropylamine, monoethanolamine, diethanolamine, triethanolamine, diglyclolamine, triisopropanolamine, choline, 2-methylthiopropylamine, bisallylamine, 2-butoxyethylamine, morpholine, cyclododecylamine, or benzylamine. Amine salts are often preferred because they are water-soluble and lend themselves to the preparation of desirable aqueous based herbicidal compositions.

Suitable esters include those derived from C₁-C₁₂ alkyl, C₃-C₁₂ alkenyl or C₃-C₁₂ alkynyl alcohols, such as methanol, isopropanol, butanol, 2-ethylhexanol, butoxyethanol, methoxypropanol, allyl alcohol, propargyl alcohol or cyclohexanol.

In the composition of this invention, the weight ratio on an acid equivalent basis of the dicamba component to glyphosate component at which the herbicidal effect is synergistic lies within the range of between about 8:1 and about 1:8. Preferably the weight ratio of the dicamba component to the glyphosate component lies within the range of between about 4:1 and about 1:4 with a weight ratio of between about 2:1 and 1:2 being preferred and a weight ratio of about 1:1 being especially preferred.

The rate at which the synergistic composition is applied will depend upon the particular type of weed to be controlled, the degree of control required, and the timing and method of application. In general, the composition of the invention can be applied at an application rate of between about 100 grams of acid equivalents per hectare (g ae/ha) and about 2000 g ae/ha based on the total amount of active ingredients in the composition. An application rate of between about 200 g ae/ha and about 1000 g ae/ha is preferred. In an especially preferred embodiment of the invention, the dicamba component is applied at a rate of between about 35 g ae/ha and about 560 g ae/ha and the glyphosate component is applied at a rate of between about 35 g ae/ha and about 1120 g ae/ha.

The components of the synergistic mixture of the present invention can be applied either separately or as part of a multipart herbicidal system.

The synergistic mixture of the present invention can be applied in conjunction with one or more other herbicides to control a wider variety of undesirable vegetation. When used in conjunction with other herbicides, the composition can be formulated with the other herbicide or herbicides, tank mixed with the other herbicide or herbicides or applied sequentially with the other herbicide or herbicides. Some of the herbicides that can be employed in conjunction with the synergistic composition of the present invention include: 4-CPA; 4-CPB; 4-CPP; 2,4-D; 3,4-DA; 2,4-DB; 3,4-DB; 2,4-DEB; 2,4-DEP; 3,4-DP; 2,3,6-TBA; 2,4,5-T; 2,4,5-TB; acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofluor, benzoylprop, benzthiazuron, bicyclopyrone, bifenox, bilanafos, bispyribac, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chlorprocarb, carfentrazone, CDEA,

CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, di-allate, dichlobenil, dichloralurea, dichlormate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P, fenoxasulfone, fenteracol, fenthiaprop, fentrazamide, fenuron, ferrous sulfate, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, furyloxyfen, glufosinate, glufosinate-P, halosafen, halosulfuron, haloxydine, haloxyfop, haloxyfop-P, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron,

MAA, MAMA, MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, parafluron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thiobencarb, tiocarbazil, tioclorim, topramezone, tralkoxydim, tri-allate, triasulfuron, triaziflam, tribenuron, tricamba, triclopyr, tridiphane, trietazine, trifloxysulfuron, trifluralin, triflusulfuron, trifop, trifopsime, trihydroxytriazine, trimeturon, tripropindan, tritac tritosulfuron, vernolate and xylachlor.

The synergistic composition of the present invention is particularly useful when used on glyphosate-tolerant, glufosinate-tolerant, 2,4-D-tolerant, dicamba-tolerant or imiazolinone-tolerant crops. It is generally preferred to use the synergistic composition of the present invention in combination with herbicides that are selective for the crop being treated and which complement the spectrum of weeds controlled by these compounds at the application rate employed. It is further generally preferred to apply the synergistic composition of the present invention and other complementary herbicides at the same time, either as a combination formulation or as a tank mix.

The synergistic composition of the present invention can generally be employed in combination with known herbicide safeners, such as benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, 829148 and N-phenylsulfonylbenzoic acid amides, to enhance their selectivity.

In practice, it is preferable to use the synergistic composition of the present invention in mixtures containing an herbicidally effective amount of the herbicidal components along with at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water dispersible granules, or wettable powders, or liquids, such as, for example, emulsifiable concentrates, solutions, emulsions or suspensions.

Suitable agricultural adjuvants and carriers that are useful in preparing the herbicidal mixtures of the invention are well known to those skilled in the art.

Liquid carriers that can be employed include water, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methanol, ethanol, isopropanol, amyl alcohol, ethylene glycol, propylene glycol, glycerine, N-methylpyrrolidinone, N-N-dimethylalkylamides, dimethyl sulfoxide and the like. Water is generally the carrier of choice for the dilution of concentrates.

Suitable solid carriers include talc, pyrophyllite clay, silica, attapulgus clay, kaolin clay, kieselguhr, chalk, diatomaceous earth, lime, calcium carbonate, bentonite clay, Fuller's earth, cotton seed hulls, wheat flour, soybean flour, pumice, wood flour, walnut shell flour, lignin, and the like.

It is usually desirable to incorporate one or more surface-active agents into the compositions of the present invention. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Typical surface-active agents include salts of alkyl sulfates, such as diethanolammonium lauryl sulfate; alkylarylsulfonate salts, such as calcium dodecyl-benzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; and salts of mono and dialkyl phosphate esters.

Other adjuvants commonly used in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

The concentration of the active ingredients in the synergistic composition of the present invention is generally from 0.001 to 98 percent by weight. Concentrations from 0.01 to 90 percent by weight are often employed. In compositions designed to be employed as concentrates, the active ingredients are generally present in a concentration from 5 to 98 weight percent, preferably 10 to 90 weight percent. Such compositions are typically diluted with an inert carrier, such as water, before application. The diluted compositions usually applied to weeds or the locus of weeds generally contain 0.0001 to 1 weight percent active ingredient and preferably contain 0.001 to 0.05 weight percent.

The present compositions can be applied to weeds or their locus by the use of conventional ground or aerial dusters, sprayers, and granule applicators, by addition to irrigation water, and by other conventional means known to those skilled in the art.

The following example illustrate the present invention.

### EXAMPLE

Seeds of the desired test plant species were planted in Sun Gro MetroMix 306 planting mixture, which typically has a pH of 6.0 to 6.8 and an organic matter content of about 30 percent, in plastic pots with a surface area of 103.2 square centimeters (cm²). When required to ensure good germination and healthy plants, a fungicide treatment and/or other chemical or physical treatment was applied. The plants were grown for 7-36 days (d) in a greenhouse with an approximate 16 hour (h) photoperiod which was maintained at about 28° C. during the day and 26° C. during the night. Nutrients and water were added on a regular basis and supplemental lighting was provided with overhead metal halide 1000-Watt lamps as necessary. The plants were employed for testing when they reached the second or third true leaf stage.

Treatments consisted of Banvel™ (dicamba dimethylamine salt) and Durango™ herbicide (glyphosate dimethylamine salt) alone and in combinations. An aliquot of

Banvel^{TM} (dicamba dimethylamine salt) was placed in 25 milliliter (mL) glass vials and diluted in a volume of water to obtain 1.5 milligrams (mg) active ingredient (ai)/mL concentrated solutions. Subsequent concentrations of Banvel™ (dicamba dimethylamine salt) were obtained by dilution with an equal volume of water. Spray solutions of Durango™ herbicide (glyphosate dimethylamine salt) were prepared following the aforementioned procedure. An aliquot of Durango™ herbicide (glyphosate dimethylamine salt) was placed in 25 milliter (mL) glass vials and mixed in a volume of 100:2 w/w water/ammonium sulfate (AMS) dilution solution to obtain 1.5 milligrams (mg) active ingredient (ai)/mL concentrated solutions.

Compound requirements are based upon a 12 mL application volume at a rate of 187 liters per hectare (L/ha). Spray solutions of the Banvel^{TM} (dicamba dimethylamine salt) and Durango™ herbicide (glyphosate dimethylamine salt) were prepared by adding the concentrated solutions to the appropriate amount of dilution solution to form 12 mL spray solution with active ingredients in combination. Banvel™ (dicamba dimethylamine salt) and Durango™ herbicide (glyphosate dimethylamine salt) alone and in combinations were applied to the foliage of plant material with an overhead Mandel track sprayer equipped with 8002E nozzles calibrated to deliver 187 L/ha over an application area of 0.503 square meters (m²) at a spray height of 18 inches (43 cm) above average plant canopy. Control plants were sprayed in the same manner with the solvent blank.

The treated plants and control plants were placed in a greenhouse as described above and watered by sub-irrigation to prevent wash-off of the test compounds. After 14-21 d, the condition of the test plants as compared with that of the control plants was determined visually and scored on a scale of 0 to 100 percent where 0 corresponds to no injury and 100 corresponds to complete kill.

Colby's equation was used to determine the herbicidal effects expected from the mixtures (Colby, S. R. 1967. Calculation of the synergistic and antagonistic response of herbicide combinations. Weeds 15:20-22.).

The following equation was used to calculate the expected activity of mixtures containing two active ingredients, A and B:

Expected=A+B−(A×B/100)

A=observed efficacy of active ingredient A at the same concentration as used in the mixture;

B=observed efficacy of active ingredient B at the same concentration as used in the mixture.

Table I contains the data for expected and actual herbicidal growth reduction caused by relevant individual herbicides and combinations of these herbicides on agronomically important weeds.

TABLE I
Herbicidal effects of Dicamba and Glyphosate and combinations
of the two herbicides on select broadleaf weeds.

| Application | | | | | | | | | | | |
|---|---|---|---|---|---|---|---|---|---|---|---|
| Rate (g/ha) | | | | | | | | | | | |
| Di- | Glypho- | | | CHEAL | | | | | | ERICA | |
| cam- | sate + | CHEAL | | GLY-RES | | COMBE | | ERICA | | GLY-RES | |
| ba | AMS | Ob | Ex | Ob | Ex | Ob | Ex | Ob | Ex | Ob | Ex |
| 35 | 0 | 34 | — | 33 | — | 18 | — | 62 | — | 62 | — |
| 70 | 0 | 40 | — | 48 | — | 25 | — | 81 | — | 83 | — |
| 140 | 0 | 52 | — | 64 | — | 43 | — | 93 | — | 95 | — |
| 280 | 0 | 61 | — | 83 | — | 42 | — | 97 | — | 97 | — |
| 0 | 35 | 8 | — | 9 | — | 7 | — | 47 | — | 0 | — |
| 0 | 70 | 12 | — | 9 | — | 27 | — | 55 | — | 0 | — |
| 0 | 140 | 57 | — | 41 | — | 49 | — | 72 | — | 3 | — |
| 0 | 280 | 66 | — | 51 | — | 58 | — | 78 | — | 7 | — |
| 35 | 35 | 48 | 39 | 60 | 39 | 62 | 24 | 83 | 80 | 64 | 62 |
| 70 | 70 | 60 | 47 | 72 | 53 | 71 | 45 | 96 | 91 | 81 | 83 |
| 140 | 140 | 87 | 79 | 88 | 79 | 83 | 71 | 98 | 98 | 91 | 95 |
| 280 | 280 | 95 | 87 | 96 | 92 | 84 | 76 | 100 | 99 | 100 | 97 |

CHEAL = Chenopodium album (Common lambsquarters/fat hen)
COMBE = Commelina benghalensis (Dayflower)
ERICA = Conyza canadensis (horseweed/marestail)
GLY-RES = Glyphosate-resistant
Ob = observed
Ex = expected

Although the invention has been described with reference to preferred embodiments and examples thereof, the scope of the present invention is not limited only to those described embodiments. As will be apparent to persons skilled in the art, modifications and adaptations to the above-described invention can be made without departing from the spirit and scope of the invention, which is defined and circumscribed by the appended claims.

What is claimed is:

1. An herbicidal mixture comprising an herbicidally effective amount of (a) a dicamba derivative and (b) a glyphosate derivative.

2. The mixture of claim 1 in which the dicamba derivative is a dicamba salt.

3. The mixture of claim 2 in which the dicamba salt is the dicamba dimethylamine salt.

4. The mixture of claim 1 in which the glyphosate derivative is a glyphosate salt.

5. The mixture of claim 4 in which the glyphosate salt is the glyphosate dimethylamine salt.

6. The mixture of claim 1 in which the weight ratio on an acid equivalent basis of the dicamba derivative component to the glyphosate derivative component is between about 8:1 and about 1:8.

7. An herbicidal composition comprising an herbicidally effective amount of the herbicidal mixture of claim 1 and an agriculturally acceptable adjuvant or carrier.

8. A method of controlling undesirable vegetation which comprises contacting the vegetation or the locus thereof with or applying to the soil to prevent the emergence of vegetation an herbicidally effective amount the herbicidal mixture of claim 1.

9. The method of claim 8 in which the undesirable vegetation is glyphosate-resistant horseweed, ragweed, amaranth, or common lambsquarters.

10. The method of claim 8 in which the undesirable vegetation is dicamba-resistant common lambsquarters.
